(19) United States
(12) Patent Application Publication
(10) Pub. No.: US 2015/0350152 A1
(43) Pub. Date: Dec. 3, 2015

(54) MANAGING AND STORING MESSAGES RECEIVED BY A MOBILE COMPUTING DEVICE

(71) Applicant: International Business Machines Corporation, Armonk, NY (US)

(72) Inventors: Christina I. Flores, Keller, TX (US); Romelia H. Flores, Keller, TX (US); Erik H. Katzen, Argyle, TX (US)

(73) Assignee: International Business Machines Corporation, Armonk, NY (US)

(21) Appl. No.: 14/289,250

(22) Filed: May 28, 2014

(51) Int. Cl. H04L 12/58; H04L 29/08

(52) U.S. Cl. CPC H04L 51/34; H04L 51/22; H04L 67/10

(57) ABSTRACT

In an approach to managing messages received by a mobile computing device, a computer retrieves a plurality of settings associated with the mobile computing device, with at least one of the plurality of settings associating a characteristic of the mobile computing device with an indication to initiate message retrieval. The computer determines the characteristic of the mobile computing device and determines, based, at least in part, on the characteristic of the mobile computing device, whether the associated indication to initiate message retrieval is received. Responsive to determining the associated indication to initiate message retrieval is received, the computer retrieves at least one message received by the mobile computing device and transmits the at least one message to a user of the mobile computing device.

### BACKGROUND OF THE INVENTION

The present invention relates generally to the field of telecommunications, and more particularly to managing and storing messages received by a mobile computing device.

Technological innovations in modern society allow people to use a mobile computing device, for example, a smart phone, to alternate between desired screens on the device and to communicate instantaneously with others. The current trend is leading to a mobile computing device that is able to deliver a user's intent with fewer intermediate steps between the initial intent and the output on the device. A user may organize, read, and respond to multiple notifications and messages, such as text messages, calls, or emails, on the device by making on-screen selections using a touch or a stylus to access the notifications.

### SUMMARY

Embodiments of the present invention disclose a method, computer program product, and a computer system for managing messages received by a mobile computing device. In an embodiment, a computer retrieves a plurality of settings associated with a mobile computing device, at least one of the plurality of settings associating a characteristic of the mobile computing device with an indication to initiate message retrieval. The computer determines the characteristic of the mobile computing device and determines, based, at least in part, on the characteristic of the mobile computing device, whether the associated indication to initiate message retrieval is received. Responsive to determining the associated indication to initiate message retrieval is received, the computer retrieves at least one message received by the mobile computing device and transmits the at least one message to a user of the mobile computing device.

### BRIEF DESCRIPTION OF THE SEVERAL VIEWS OF THE DRAWINGS

FIG. 1 is a functional block diagram illustrating a mobile computing environment, in accordance with an embodiment of the present invention.

FIG. 2 is a flowchart depicting operational steps of a queue manager for managing messages received by a mobile computing device within the mobile computing environment of FIG. 1, in accordance with an embodiment of the present invention.

FIG. 3 illustrates an exemplary user interface depicting customizations provided by the settings module of FIG. 1, in accordance with an embodiment of the present invention.

FIG. 4 depicts a block diagram of components of a data processing system, such as the mobile computing device of FIG. 1, in accordance with an embodiment of the present invention.

### DETAILED DESCRIPTION

Embodiments of the present invention recognize that mobile computing device users access messages and notifications on the device in several ways, including touching the screen of the device, providing a gesture readable by the device to interact with the device, and speaking to the device which uses technology to convert speech to mobile application commands. Embodiments of the present invention also recognize that mobile computing device technology lacks a capability to manage and prioritize received messages and to distinguish between emergency messages and regular messages, and that mobile computing device users require the ability to access, review, and respond to messages in a hands-off manner.

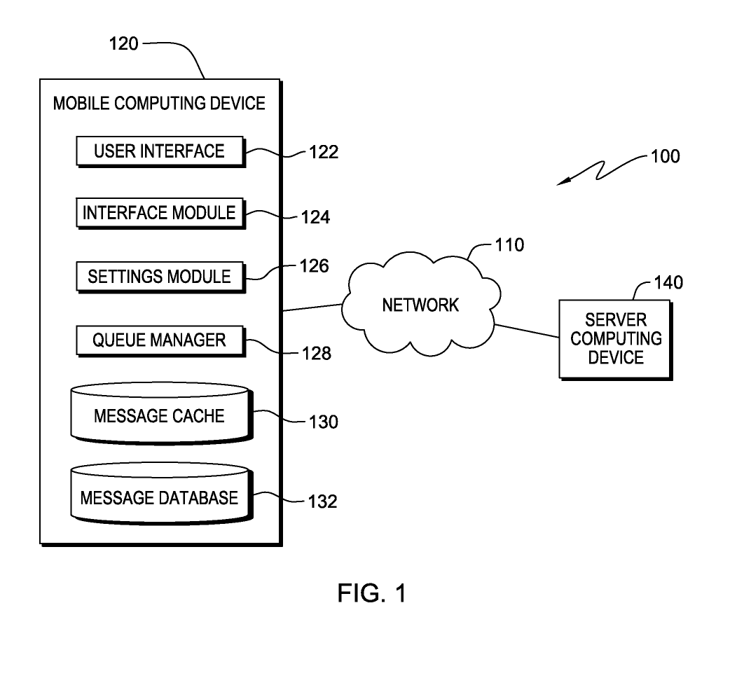

The present invention will now be described in detail with reference to the Figures. FIG. 1 is a functional block diagram illustrating a mobile computing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Mobile computing environment 100 includes mobile computing device 120 and server computing device 140, interconnected via network 110. Network 110 can be, for example, a local area network (LAN), a telecommunications network, a wide area network (WAN), such as the Internet, a virtual local area network (VLAN), or any combination of the four, and can include wired, wireless, or fiber optic connections. In general, network 110 can be any combination of connections and protocols that will support communications between mobile computing device 120 and server computing device 140, in accordance with embodiments of the present invention.

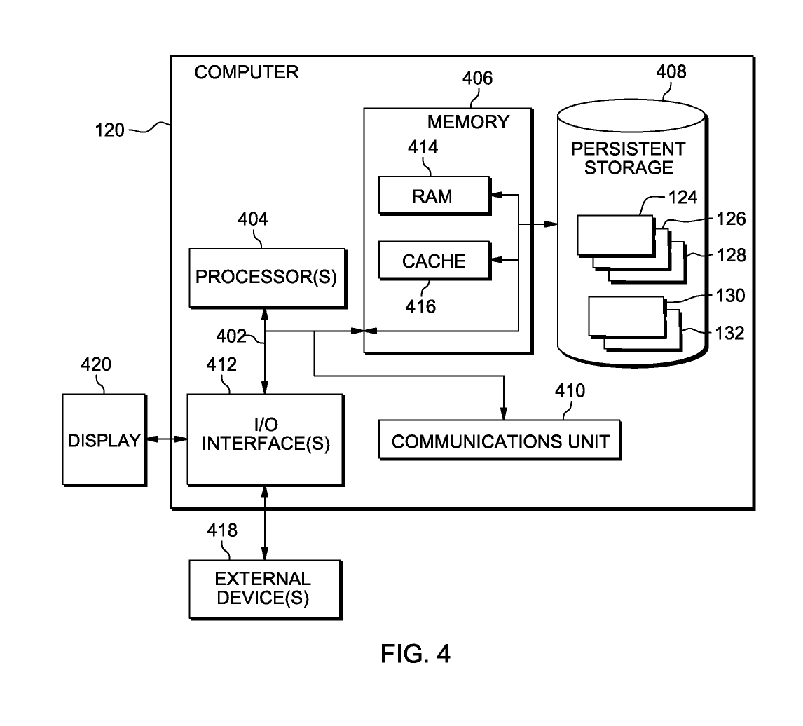

In various embodiments of the present invention, mobile computing device 120 may be a laptop computer, a tablet computer, a personal digital assistant (PDA), a smart phone, or any programmable electronic device or combination of electronic devices capable of executing machine readable program instructions and of communicating with server computing device 140 via network 110 and with various other components and mobile devices within mobile computing environment 100. Mobile computing device 120 includes text-to-speech and speech-to-text capabilities using known methods in the art. Mobile computing device 120 includes user interface (UI) 122, interface module 124, settings module 126, queue manager 128, message cache 130, and message database 132. Mobile computing device 120 may include internal and external hardware components, as depicted and described with reference to FIG. 4.

UI 122 may be, for example, a graphical user interface (GUI), a web user interface (WUI), or a touchscreen, and can display text, documents, instant message applications, user options, instructions for operation, and other application interfaces. A user interface, such as UI 122, refers to the information (such as graphics, text, and sound) an application presents to a user and the control sequences the user employs to control the application. There are many types of user interfaces. In one embodiment, UI 122 is a GUI, which is a type of interface that allows users to interact with electronic devices, such as a computer keyboard and mouse, through graphical icons and visual indicators. The actions in GUIs are often performed through direct manipulation of the graphical elements by the use of the computer keyboard or mouse. In another embodiment, UI 122 is a touchscreen, allowing input by touch of a finger or a stylus. In yet another embodiment, UI 122 can be voice and/or sound enabled. In various embodiments, UI 122 is the interface between mobile computing device 120 and queue manager 128.

Interface module 124 displays messages, including phone calls, emails, text messages, or other notifications, to a user interface, such as UI 122, so that a user of mobile computing device 120 can listen to, view, and respond to the messages. In an embodiment, interface module 124 determines settings, including audio settings, of a mobile computing device, for example, mobile computing device 120. Interface module 124 can determine whether mobile computing device 120 is set for loud volume, silent, or if wirelessly enabled. Interface module 124 can also customize display of messages based on settings defined by the user of mobile computing device 120, for example, in settings module 126.

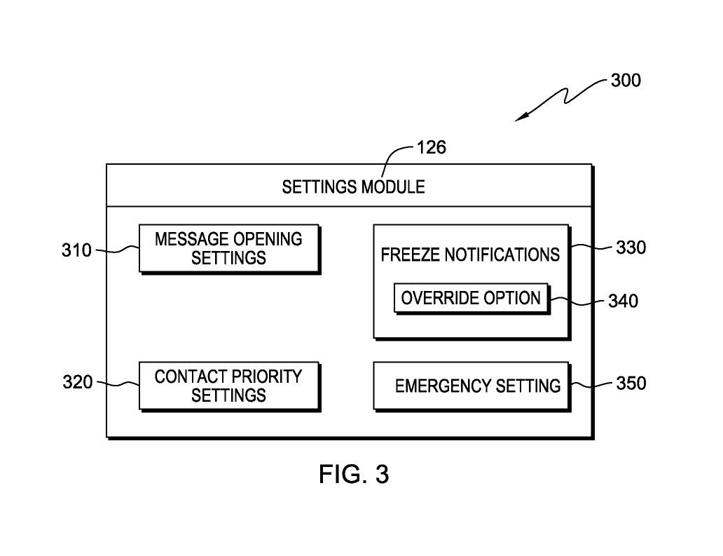

Settings module 126 provides a user of mobile computing device 120 with options for customizing the device 120 and operation of queue manager 128. The user may create custom techniques for opening messages, customize how messages are organized or appear when received from certain contacts, set a priority ranking for contacts, customize how messages appear based on what time the message is received, set sound or movement commands for retrieval of messages, and customize emergency settings for urgent messages. Settings module 126 is discussed further with reference to FIG. 3.

Queue manager 128 manages messages received by mobile computing device 120 and organizes the messages based on first received, and then next received, and so on. Queue manager 128 can re-organize messages according to user defined settings. Queue manager 128 retrieves messages from either message cache 130 or message database 132, based on user defined settings, and sends the messages for display to the user. Queue manager 128 can also store messages in message database 132 according to status, such as read, unread, or delayed.

Message cache 130 stores messages for short term storage as they are received on mobile computing device 120 for retrieval by queue manager 128 and display to the user. Received messages are stored in message cache 130 as they are received by mobile computing device 120, provided a received message does not have an associated delay time. A delay time can be set by the user in settings module 126, and can be updated by a user command after the message appears in the queue on UI 122. If no delay time is associated with a message, a default time is set to zero and the message is stored in message cache 130. If a message has an associated delay time greater than zero, message cache 130 does not store the message. For example, a user may define a setting such that emails received from contact A are automatically given a delay time of two hours. As a result, emails received from contact A are not stored in message cache 130, but are stored in message database 132 for retrieval.

Message database 132 provides long term message storage, and can store messages with an associated status and an associated delay time. When the associated delay time reaches zero, queue manager 128 moves the message to message cache 130 for retrieval by queue manager 128. Message database 132 can also store messages after viewing by the user.

Server computing device 140 may be a management server, a web server, a mobile computing device, or any other electronic device or computing system capable of receiving and sending data. In other embodiments, server computing device 140 may represent a server computing system utilizing multiple computers as a server system, such as in a cloud computing environment. In another embodiment, server computing device 140 may be a laptop computer, a tablet computer, a netbook computer, a personal computer (PC), a desktop computer, or any programmable electronic device capable of communicating with mobile computing device 120 via network 110. In another embodiment, server computing device 140 represents a computing system utilizing clustered computers and components (e.g., database server computer, application server computers, etc.) that act as a single pool of seamless resources when accessed within mobile computing environment 100. Server computing device 140 provides support for operations and service for mobile computing device 120 and between the device 120 and various other components and mobile devices (not shown) within mobile computing environment 100 via network 110. In an embodiment, each of the programs included on mobile computing device 120 may be located on server computing device 140, or elsewhere within mobile computing environment 100 with access to messages received by the device 120.

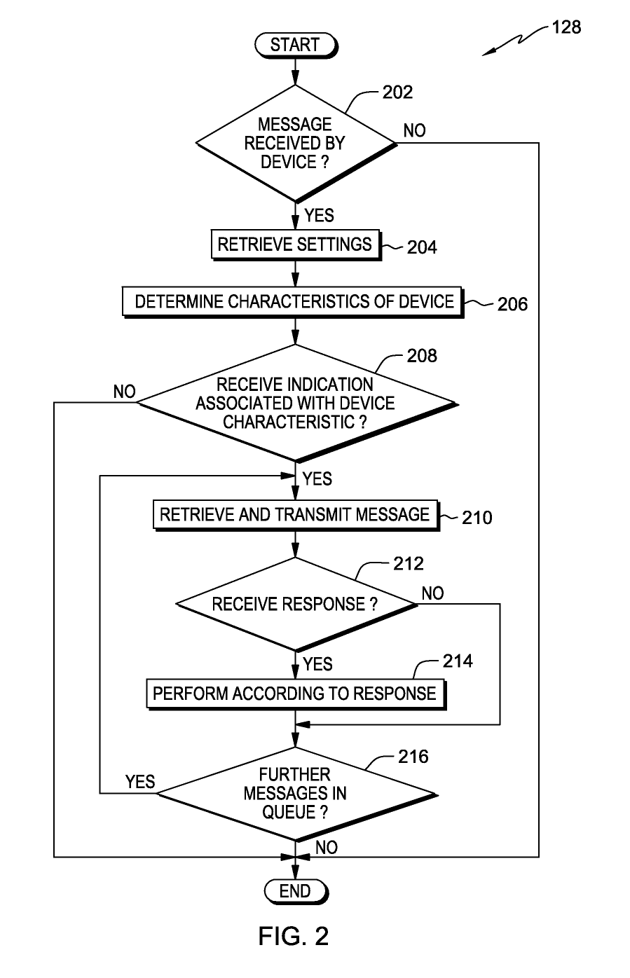

FIG. 2 is a flowchart depicting operational steps of queue manager 128 for managing messages received by mobile computing device 120 within mobile computing environment 100, in accordance with an embodiment of the present invention.

Queue manager 128 determines whether a message is received by mobile computing device 120 (decision block 202). Messages, including phone calls, calls made via the Internet, emails, text messages, or other notifications, are sent to a user operating mobile computing device 120. Upon determining a message is received, queue manager 128 stores the messages in message cache 130 in a first received, first viewed manner. If no messages are received (decision block 202, “no” branch), queue manager 128 ends processing.

If at least one message is received (decision block 202, “yes” branch), queue manager 128 retrieves settings associated with the mobile computing device (step 204). A user operating mobile computing device 120 can define settings in settings module 126, for example, message opening settings such as a defined indication to initiate retrieval of a message. A user may define an indication to retrieve messages associated with various characteristics of the mobile computing device. For example, a characteristic of the mobile computing device may be an audio setting, and the user may define message retrieval indications associated with varying audio settings, such as when mobile computing device 120 is set to loud volume, a user may make a sound, for example, snap fingers, clap hands, or issue a customized voice command such as “open message” or “read now.” If the volume is set to silent, a message opening indication may include a pre-defined gesture or a passcode or password entered on a touchscreen of the device. Queue manager 128 may detect a gesture, such as a figure eight motion, or turning to the left or right, using an internal accelerometer available within mobile computing device 120 and other mobile phones. In another embodiment, mobile computing device 120 may include a camera which can directly detect input gestures by the user.

In an embodiment, in settings module 126, a user may set priority settings for contacts. For example, a user may determine one or multiple priority contacts, such as family, friends, or co-workers, and messages received from the priority contact may automatically move to first in queue for message opening or may appear differently than other messages, including appearing in a different color, in bold type, in conjunction with an emoticon or other object, or any such manner to distinguish a message received from a priority contact as opposed to from a regular contact. In another example, a message received from a high priority contact, such as a spouse or child, may have a sound associated with the message notification.

Queue manager 128 determines characteristics, including, for example, audio settings, of the device (step 206). In an embodiment, queue manager 128 accesses settings of mobile computing device 120 to determine characteristics of the device, such as audio settings including whether the device 120 is set to silent, vibrate only, or whether the volume is set to loud, or some other setting, including set to be wirelessly enabled. In another embodiment, interface module 124 determines characteristics of mobile computing device 120, such as whether the device 120 is set to a silent mode, another volume setting, or to a wireless mode.

Queue manager 128 determines whether an indication associated with the determined device characteristic is received (decision block 208). For example, if queue manager 128 determines mobile computing device 120 is set to silent, an associated indication may be a gesture, or if the device volume is on, an indication may be to state “open message.” If no indication is received, or if an incorrect indication is received for the determined setting (decision block 208, “no” branch), queue manager 128 ends processing. If the indication is received, for example, the gesture (decision block 208, “yes” branch), queue manager 128 retrieves a message from message cache 130 and transmits the message to be displayed (step 210). In silent mode, for example, queue manager 128 sends the message to interface module 124 for display on UI 122, and text-to-speech capabilities are disabled. In an embodiment, queue manager 128 sends the message to UI 122 for display to the user of mobile computing device 120.

In various embodiments, settings module 126 includes options for a user to secure access to messages on mobile computing device 120, for example, by providing for a biometrics analysis in addition to the message opening settings. The biometric analysis can enable a user to lock the device and only upon detecting the user, for example, based on vocal tone, pitch, wavelength, etc., will queue manager 128 accept the indication for opening a message.

In an embodiment, prior to transmitting a message to be displayed, queue manager 128 initiates a sorting of messages retrieved from message cache 130 according to settings defined in settings module 126, for example, based on contact priority, time received or message type, such as voice mail, email, or text message. In the embodiment, queue manager 128 retrieves messages from message cache 130 with delay times of zero. A user may define a delay time to be associated with a message when the message is received, for example, setting emails to have a delay time corresponding to 6:00 pm, so that emails are not received until after work. Until the time is reached, the emails are stored in message database 132.

In other audio setting modes, such as a wirelessly enabled mode, interface module 124 transmits the message via a wireless device, for example, within a vehicle the message is transmitted via the vehicle's communications system and the message is announced. In another embodiment, for example, the mobile computing device may be set to a loud volume, and interface module 124 may transmit the message via an intelligent personal assistant (IPA) of mobile computing device 120 for the IPA to read and vocalize the message. An IPA is a mobile device technology that provides the ability to convert text on the device to speech, and to convert speech received by the device to mobile application commands.

Queue manager 128 determines whether a response is received (decision block 212). For example, after hearing a message read aloud, the user can respond to the IPA with a verbal command of “reply”, or a verbal response, “delete” to delete the message or “repeat” to repeat the message, or the user may say “delay” and announce a unit of time. In an embodiment, if silent mode is enabled, a user response may be to shake the device two times for delete, or three times to save the message, or any other movement based on the user defined motion created or set in settings module 126. If no response is received (decision block 212, “no” branch), queue manager 128 determines whether there are further messages in the queue stored in message cache 130 (decision block 216). If a response is received (decision block 212, “yes” branch), queue manager 128 performs according to the response (step 214), for example, queue manager 128 can delete the message or can store the message with the associated response. Queue manager 128 stores messages with their associated status and any included delay time in message database 132. Queue manager 128 manages the stored messages and associated delay times, which act as a timer, so that when a delay time approaches or expires, queue manager 128 can return the message to the queue with an “unread” status.

In an embodiment, the IPA of the mobile computing device can receive and interpret additional commands. For example, if a user issues a command to open the third message in the queue, rather than proceeding to the next in order, the IPA interprets the command and sends the command to queue manager 128.

Queue manager 128 determines whether there are any further messages in the queue (decision block 216). If there are further messages (decision block 216, “yes” branch), queue manager 128 returns to step 210 to transmit the next message to the user. If there are no further messages (decision block 216, “no” branch), queue manager 128 ends processing.

In an example, mobile computing device 120 receives a text message “TM_1” at 8:00 am, a phone call, “PC_1” at 9:00 am, another text message, “TM_2” at 9:15 am, and an email “EM_1” at 11:00 am. A user of mobile computing device 120 wants to check messages at 1:00 pm, and initiates queue manager 128 by using a custom message opening command, verbally stating, “check messages.” Queue manager 128 determines the device is set to a loud volume, and that “check messages” is the correct indication for the audio setting, and retrieves TM_1 to transmit to the user. The IPA of the device reads the message, and the user then states “reply” and provides a response, which is sent to the sender of TM_1. Queue manager 128 then retrieves the next message, PC_1, and announces the call to the user as a missed call. The user can then state “delay one week” and queue manager 128 stores PC_1 with an associated delay time of one week. Queue manager 128 retrieves TM_2, transmits the message to the user, and the user decides not to respond and instead states “next message.” Queue manager 128 performs according to the response and transmits EM_1 to the user.

FIG. 3 illustrates an exemplary user interface depicting customizations provided by settings module 126, in accordance with an embodiment of the present invention.

UI 300 includes message opening settings 310, contact priority settings 320, freeze notifications 330, override option 340, and emergency setting 350.

Message opening settings 310 allow a user to set indications for opening messages retrieved by queue manager 128 based on audio settings of mobile computing device 120. For example, a user can define a custom movement setting, such as a figure-eight motion performed with the phone or gesture detected by a camera of the phone, to indicate to queue manager 128 to retrieve messages for viewing. In various other embodiments, a user can set an option in settings module 126 to alter the manner in which messages are viewed or read. For example, a user may opt for ‘quick select’ which allows the user to view any messages in the queue in order to manually access certain messages ahead of others.

Contact priority settings 320 provide a user with the capability to prioritize contacts and to set display options or sounds to be applied when a message is received from various contacts.

Freeze notifications 330 allows a user to set a period of time when queue manager 128 can add messages to the queue but does not transmit messages or message notifications. The user can define a profile based on the user's schedule or calendar, or the user may manually set the period of time, including a start time and an end time. In an example, freeze notifications 330 contains drop down menus designating days of the week and blocks of time. The user can set freeze notifications 330 for the work day or work week, and any incoming message during that time is stored in message database 132, rather than message cache 130, and is not transmitted to UI 122 for display to the user, until the designated end time of the freeze notifications.

Override option 340 operates in conjunction with freeze notifications 330 and allows a user to override the freeze notification, for example, when the user is taking a lunch break and has an opportunity to review messages. The user can set the override exception to begin with a designated command, such as “override enable”, which can temporarily cancel the freeze notification setting. The user can then receive messages from queue manager 128, until the user provides a custom command for ending the override, such as “override disable.”

Emergency setting 350 allows a user to determine one or multiple contacts to which to apply the emergency setting, to set how an emergency is determined, as distinguished from a regular message from a contact, and how the user is to be notified of the emergency or what action is to be taken when an emergency situation is detected. For example, the user may set family contacts, and if anyone in the user's family calls three times in less than ten minutes, an audible alarm goes off on the mobile device, or a light on the mobile device begins flashing, for example. In embodiments, in an emergency situation, settings regarding alarms or lights on the mobile computing device occur regardless of characteristics of the device, such as whether the device is set to silent, loud, or wireless.

In an embodiment, emergency setting 350 provides an option for a user to define emergency signals, which are transmitted to selected contacts when queue manager 128 detects an emergency situation. For example, a user may set parameters for an emergency situation, such as an abrupt acceleration or deceleration of mobile computing device 120 as detected by GPS or an accelerometer operating within the device 120. Additionally, a user may set a parameter that detects that the user has not responded to or checked messages in a defined period of time, possibly indicating illness or injury. Queue manager 128 can send the defined emergency signal to selected contacts, for example, a text message that says “please call emergency services,” upon detecting the emergency situation.

In various other embodiments, a user may define a profile in settings module 126 to include GPS technology, for example, when queue manager 128 detects the user is at work, using the GPS functionality of mobile computing device 120, freeze notifications 330 is automatically enabled. In another embodiment, settings module 126 can include a connection with a social network, or a social media profile of the user. For example, queue manager 128 may retrieve information from the user's social media profile indicating the user is going on a vacation and will not have access to mobile computing device 120. Queue manager 128 can then temporarily, for the length of the vacation, cancel an emergency signal setting regarding inactivity of the device.

FIG. 4 depicts a block diagram of components of mobile computing device 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Mobile computing device 120 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

In the depicted embodiment, interface module 124, settings module 126, queue manager 128, message cache 130, and message database 132 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, a read-only memory (ROM), an erasable programmable read-only memory (EPROM), a flash memory, or any other computer-readable storage media that is capable of storing program instructions or digital information. In other embodiments, queue manager 128 and message cache 130 may be stored in cache 416.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including server computing device 140. In these examples, communications unit 410 includes one or more network interface cards. Communications unit 410 may provide communications through the use of either or both physical and wireless communications links. Interface module 124, settings module 126, queue manager 128, message cache 130, and message database 132 may be downloaded to persistent storage 408 through communications unit 410.

I/O interface(s) 412 allows for input and output of data with other devices that may be connected to mobile computing device 120. For example, I/O interface(s) 412 may provide a connection to external device(s) 418 such as a keyboard, a keypad, a touch screen, a microphone and/or some other suitable input device. External device(s) 418 can also include portable computer-readable storage media such as, for example, thumb drives, portable optical or magnetic disks, and memory cards. Software and data used to practice embodiments of the present invention, e.g., interface module 124, settings module 126, queue manager 128, message cache 130, and message database 132 can be stored on such portable computer-readable storage media and can be loaded onto persistent storage 408 or cache 416 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for managing messages received by a mobile computing device, the method comprising:
retrieving, by one or more computer processors, a plurality of settings associated with a mobile computing device, at least one of the plurality of settings associating a characteristic of the mobile computing device with an indication to initiate message retrieval;
determining, by one or more computer processors, the characteristic of the mobile computing device;
determining, by one or more computer processors, based, at least in part, on the characteristic of the mobile computing device, whether the associated indication to initiate message retrieval is received;
responsive to determining the associated indication to initiate message retrieval is received, retrieving, by one or more computer processors, at least one message received by the mobile computing device; and
transmitting, by one or more computer processors, the at least one message to a user of the mobile computing device.

2. The method of claim 1, further comprising:
determining, by one or more computer processors, whether a response is received from the user of the mobile computing device to the at least one message; and
responsive to determining a response is received, performing, by one or more computer processors, an action according to the response, the action including at least one of deleting the at least one message, replying to the at least one message, delaying the at least one message, and repeating the at least one message.

3. The method of claim 2, further comprising:
determining, by one or more computer processors, whether the response includes a delay time; and
responsive to determining the response includes a delay time, storing, by one or more computer processors, the message with the delay time.

4. The method of claim 1, wherein determining, by one or more computer processors, based, at least in part, on the characteristic of the mobile computing device, whether the associated indication to initiate message retrieval is received further comprises:
retrieving, by one or more computer processors, an audio setting of the mobile computing device;
determining, by one or more computer processors, an indication to initiate message retrieval for the audio setting is a movement of the mobile computing device; and
determining, by one or more computer processors, the movement of the mobile computing device is performed.

5. The method of claim 1, further comprising:
determining, by one or more computer processors, at least one of the plurality of settings associated with the mobile computing device defines an emergency situation for the user of the mobile computing device and an associated action to be taken in the emergency situation;
detecting, by one or more computer processors, the emergency situation; and
responsive to detecting the emergency situation, performing, by one or more computer processors, the associated action to be taken in the emergency situation.

6. The method of claim 1, further comprising:
determining, by one or more computer processors, at least one of the plurality of settings associated with the mobile computing device defines a period of time, including a start time and an end time, in which no messages are to be transmitted to the user;
receiving, by one or more computer processors, at least one message between the start time and the end time; and
responsive to receiving at least one message between the start time and the end time, storing, by one or more computer processors, the at least one message until the end time.

7. The method of claim 6, further comprising:
determining, by one or more computer processors, at least one of the plurality of settings associated with the mobile computing device defines an override command, the override command allowing access to the at least one message between the start time and the end time;
receiving, by one or more computer processors, the override command between the start time and the end time; and
responsive to receiving the override command between the start time and the end time, transmitting, by one or more computer processors, the at least one message to the user of the mobile computing device.

8. A computer program product for managing messages received by a mobile computing device, the computer program product comprising:
one or more computer readable storage media and program instructions stored on the one or more computer readable storage media, the program instructions comprising:
program instructions to retrieve a plurality of settings associated with a mobile computing device, at least one of the plurality of settings associating a characteristic of the mobile computing device with an indication to initiate message retrieval;
program instructions to determine the characteristic of the mobile computing device;
program instructions to determine based, at least in part, on the characteristic of the mobile computing device, whether the associated indication to initiate message retrieval is received;
responsive to determining the associated indication to initiate message retrieval is received, program instructions to retrieve at least one message received by the mobile computing device; and
program instructions to transmit the at least one message to a user of the mobile computing device.

9. The computer program product of claim 8, further comprising:
program instructions to determine whether a response is received from the user of the mobile computing device to the at least one message; and
responsive to determining a response is received, program instructions to perform an action according to the response, the action including at least one of deleting the at least one message, replying to the at least one message, delaying the at least one message, and repeating the at least one message.

10. The computer program product of claim 9, further comprising:
program instructions to determine whether the response includes a delay time; and
responsive to determining the response includes a delay time, storing, by one or more computer processors, the message with the delay time.

11. The computer program product of claim 8, wherein the program instructions to determine, based, at least in part, on the characteristic of the mobile computing device, whether the associated indication to initiate message retrieval is received further comprise:
program instructions to retrieve an audio setting of the mobile computing device;
program instructions to determine an indication to initiate message retrieval for the audio setting is a movement of the mobile computing device; and
program instructions to determine the movement of the mobile computing device is performed.

12. The computer program product of claim 8, further comprising:
program instructions to determine at least one of the plurality of settings associated with the mobile computing device defines an emergency situation for the user of the mobile computing device and an associated action to be taken in the emergency situation;
program instructions to detect the emergency situation; and
responsive to detecting the emergency situation, program instructions to perform the associated action to be taken in the emergency situation.

13. The computer program product of claim 8, further comprising:
program instructions to determine at least one of the plurality of settings associated with the mobile computing device defines a period of time, including a start time and an end time, in which no messages are to be transmitted to the user;
program instructions to receive at least one message between the start time and the end time; and
responsive to receiving at least one message between the start time and the end time, program instructions to store the at least one message until the end time.

14. The computer program product of claim 13, further comprising:
program instructions to determine at least one of the plurality of settings associated with the mobile computing device defines an override command, the override command allowing access to the at least one message between the start time and the end time;
program instructions to receive the override command between the start time and the end time; and
responsive to receiving the override command between the start time and the end time, program instructions to transmit the at least one message to the user of the mobile computing device.

15. A computer system for managing messages received by a mobile computing device, the computer system comprising:
one or more computer processors;
one or more computer readable storage media;
program instructions stored on the one or more computer readable storage media for execution by at least one of the one or more computer processors, the program instructions comprising:
program instructions to retrieve a plurality of settings associated with a mobile computing device, at least one of the plurality of settings associating a characteristic of the mobile computing device with an indication to initiate message retrieval;
program instructions to determine the characteristic of the mobile computing device;
program instructions to determine based, at least in part, on the characteristic of the mobile computing device, whether the associated indication to initiate message retrieval is received;
responsive to determining the associated indication to initiate message retrieval is received, program instructions to retrieve at least one message received by the mobile computing device; and
program instructions to transmit the at least one message to a user of the mobile computing device.

16. The computer system of claim 15, further comprising:
program instructions to determine whether a response is received from the user of the mobile computing device to the at least one message; and
responsive to determining a response is received, program instructions to perform an action according to the response, the action including at least one of deleting the at least one message, replying to the at least one message, delaying the at least one message, and repeating the at least one message.

17. The computer system of claim 15, wherein the program instructions to determine, based, at least in part, on the characteristic of the mobile computing device, whether the associated indication to initiate message retrieval is received further comprise:
program instructions to retrieve an audio setting of the mobile computing device;
program instructions to determine an indication to initiate message retrieval for the audio setting is a movement of the mobile computing device; and
program instructions to determine the movement of the mobile computing device is performed.

18. The computer system of claim 15, further comprising:
program instructions to determine at least one of the plurality of settings associated with the mobile computing device defines an emergency situation for the user of the mobile computing device and an associated action to be taken in the emergency situation;
program instructions to detect the emergency situation; and
responsive to detecting the emergency situation, program instructions to perform the associated action to be taken in the emergency situation.

19. The computer system of claim 15, further comprising:
program instructions to determine at least one of the plurality of settings associated with the mobile computing device defines a period of time, including a start time and an end time, in which no messages are to be transmitted to the user;
program instructions to receive at least one message between the start time and the end time; and
responsive to receiving at least one message between the start time and the end time, program instructions to store the at least one message until the end time.

20. The computer system of claim 19, further comprising:
program instructions to determine at least one of the plurality of settings associated with the mobile computing device defines an override command, the override command allowing access to the at least one message between the start time and the end time;
program instructions to receive the override command between the start time and the end time; and
responsive to receiving the override command between the start time and the end time, program instructions to transmit the at least one message to the user of the mobile computing device.
